(19) United States
(12) Patent Application Publication
(10) Pub. No.: US 2007/0161418 A1
(43) Pub. Date: Jul. 12, 2007

(54) Sliding cover of smartphone

(75) Inventors: Hsiang Chen, Taipei (TW); Shih-Hsuan Wang, Taipei (TW)

Correspondence Address: BACON & THOMAS, PLLC, 625 SLATERS LANE, FOURTH FLOOR, ALEXANDRIA, VA, 22314, US

(73) Assignee: INVENTEC CORPORATION, Taipei (TW)

(21) Appl. No.: 11/330,242

(22) Filed: Jan. 12, 2006

(51) Int. Cl. H04M 1/00

(52) U.S. Cl. 455/575.4

(57) ABSTRACT

The present invention provides a smartphone comprising a sliding cover including two troughs provided at both sides thereof, a first signal contact provided under one of the troughs, and a phone body including a keypad for mobile phone provided adjacent to one end thereof, a button region for video games provided adjacent to the other end thereof, two grooves provided on its both sides and adapted to matingly engage with the troughs, and second and third signal contacts provided on either groove. Thus, the smartphone may operate as a typical PDA when the phone body is fully covered by the sliding cover, as a typical video game machine when the sliding cover moves to one end of the phone body to expose the button region and let the first signal contact electrically contact the second signal contact, or as a typical mobile phone when the sliding cover moves to the other end of the phone body to expose the keypad and let the first signal contact electrically contact the third signal contact.

### FIELD OF THE INVENTION

The present invention relates to mobile-based smartphones, and more particularly to a smartphone having a sliding cover such that different functions (e.g., mobile phone and video game) of the smartphone can be switched among them by sliding the sliding cover in different directions.

### BACKGROUND OF THE INVENTION

The Internet and mobile communications have known a rapid, spectacular development in recent years. Thus, many types of advanced network and communication products are commercially available and they are widely used in our daily life and work. Such trend not only increases the speed and efficiency of information communication but also brings a lot of convenience to our life and work.

The availability of various electronic products is even faster as electronics industry makes progress significantly in recent several decades. Consumer-oriented electronic products (e.g., PDAs (Personal Digital Assistants), mobile phones, etc.) are important ones of them. Such electronic products are characterized in that they are compact, portable, and inexpensive. Moreover, many advanced features are added therein. Thus, such type of electronic device not only has features available from typical mobile phone or serves as notepad but also has features such as the Internet access, downloading, e-shopping, etc. associated with wireless data communication. As a result, Internet access and mobile communications are made easy and thus for most people they gradually become a part of their daily life and work.

But mobile phone was originally designed to enable a person to communicate with another person in any place and PDA was originally designed to become a personal information management (PIM) tool. For example, scheduler, notepad, phonebook, etc. are basic functionalities of PDA. Thus, PDA is also called as organizer.

In addition, both GSM (Global System for Mobile Communications) and AMPS (Advanced Mobile Phone System) (i.e., the standard for analog mobile phone) are not capable of effecting large data transfer due to limited bandwidth. In fact, only voice data and small amount of graphics data can be communicated thereover. In another regard, an era of integrating communications and computer has come. The latest type of mobile phone not only has advanced communication features but also has incorporated wireless data transfer and notepad features thereinto. An example of such type of mobile phone is smartphone which incorporates features of typical mobile phone and PDA. The smartphone thus is capable of effecting mobile-based voice communications, doing PIM, sending or receiving e-mails, playing video games, watching news, downloading, facsimiling, or linking intranet. Moreover, the smartphone has an increased degree of touching comfort and improved screen quality. Thus, smartphones have become powerful 3G mobile phones. In this regard, smartphones are gaining popularity rapidly.

Generally speaking, a wide variety of smartphones are designed and produced by manufacturers and are commercially available on the market. Typically, smartphones have above features. Moreover, size of smartphone is limited so as to meet the requirement of enabling a person to carry it easily. Undesirably, operation convenience of smartphone is adversely affected. In fact, users experienced many inconviences and limitations in operating a smartphone. Also, these drawbacks have not overcome.

Hence, unique features are the key to win over other manufacturers in this competitive smartphone market. Thus, it is desirable to provide a novel smartphone having functional and operating advantages in order to increase its sale as well as bring a lot of use convenience to vast users.

### SUMMARY OF THE INVENTION

After considerable research and experimentation, a smartphone having a sliding cover according to the present invention has been devised so as to overcome the above drawbacks (e.g., size limitations and inconvenient operation) of the prior art as described in the background of the specification.

It is an object of the present invention to eliminate inconvenience and limitations in operating a smartphone caused by the prior requirement of enabling a person to carry it easily.

It is another object of the present invention to a smartphone having a sliding cover such that different functions (e.g., mobile phone and video game) of the smartphone can be switched among them by sliding the sliding cover in different directions while maintaining great operating convenience.

To achieve the above and other objects, the present invention provides a smartphone comprising a sliding cover including two troughs provided at both sides of its bottom surface, and a first signal contact provided under one of the troughs; and a phone body including a keypad including function keys for mobile phone provided adjacent to one end of its top surface, a button region including function keys for video games provided adjacent to the other end of its top surface, two lengthwise grooves provided on its both sides, the grooves being adapted to matingly engage with the troughs such that both the grooves and the troughs are adapted to slide relative to each other, and second and third signal contacts provided on an inner surface of either groove. By utilizing this sliding cover, the smartphone may operate as a typical PDA when the phone body is fully covered by the sliding cover. The smartphone may operate as a typical mobile phone and the first signal contacts electrically contact the third signal contacts when the sliding cover moves to the other end of the phone body by sliding the troughs over the grooves to expose the keypad. The smartphone may operate as a typical video game machine and the first signal contacts electrically contact the second signal contacts when the sliding cover moves to one end of the phone body by oppositely sliding the troughs over the grooves to expose the button region.

The above and other objects, features and advantages of the present invention will become apparent from the following detailed description taken with the accompanying drawings.

### BRIEF DESCRIPTION OF THE DRAWINGS

FIG. 1 is a perspective view of a preferred embodiment of smartphone according to the invention;

FIG. 2 is a view similar to FIG. 1 showing a sliding operation of the cover; and

FIG. 3 is a view similar to FIG. 1 showing another sliding operation of the cover.

### DETAILED DESCRIPTION OF THE PREFERRED EMBODIMENTS

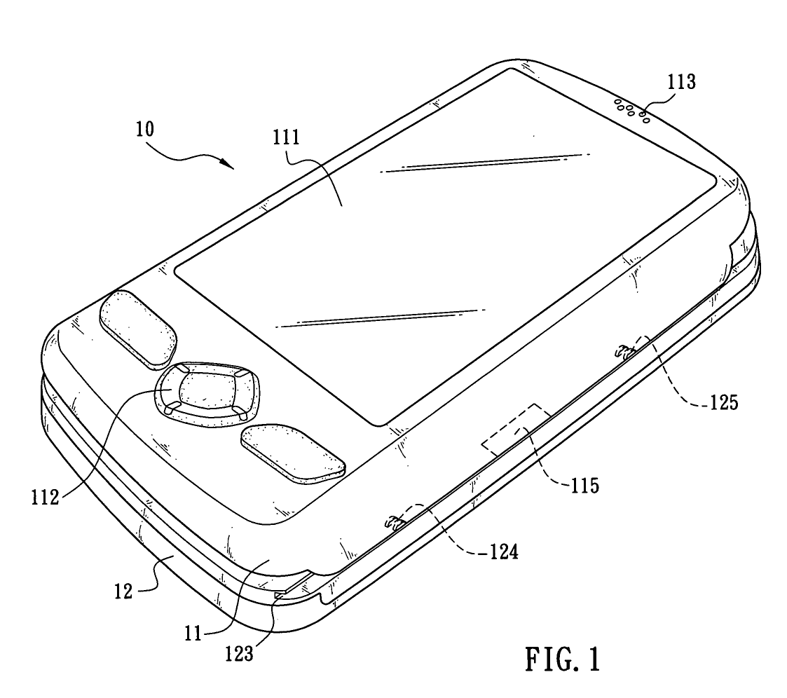

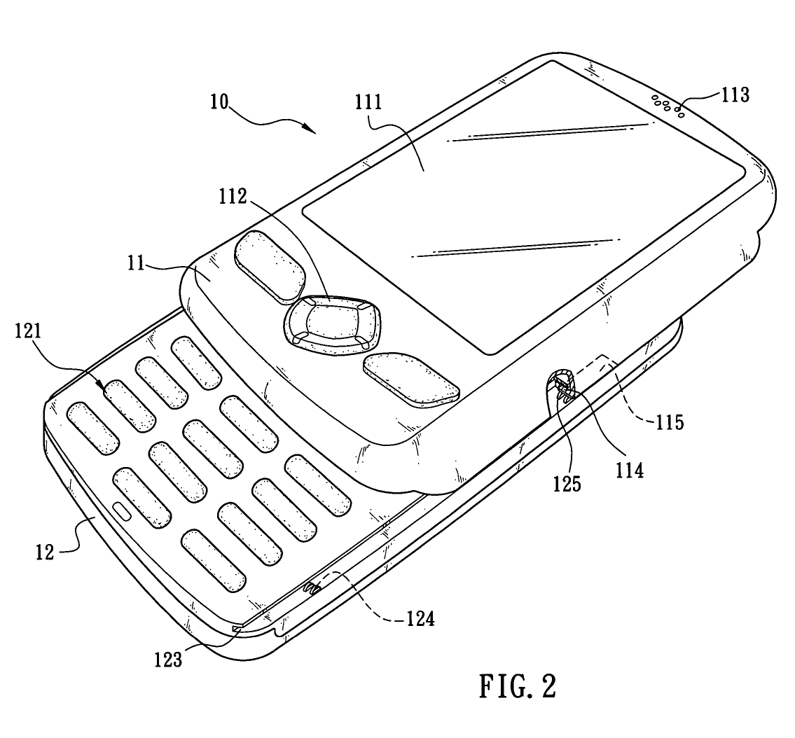

Referring to FIGS. 1 and 2, a smartphone 10 in accordance with a preferred embodiment of the invention comprises two constituent components (e.g., a sliding cover 11 and a phone body 12). Preferably, both the sliding cover 11 and the phone body 12 are made of wear-proof material of low friction coefficient in order to facilitate the sliding cover 11 to slide relative to the phone body 12.

In the embodiment, on a top surface of the sliding cover 11 there are provided a screen 111, a direction button 112, and a speaker 113. The screen 111 is adapted to display information including icons or characters of the smartphone 10. The direction button 112 is provided adjacent to one end of the screen 111 and is adapted to control direction. The speaker 113 is provided adjacent to the other end of the screen 111 and is adapted to amplify sound. A plurality of holes are formed on the speaker 113. It is well understood by those skilled in the art that locations of the screen 111, the direction button 112, and the speaker 113 may be altered or changed without departing from the scope and spirit of the invention.

In the embodiment two troughs 114 are provided at both sides of the back of the sliding cover 11 (see FIG. 2) in which only one trough 114 is shown. An intermediate first signal contact 115 is provided under one of the troughs 114. The first signal contact 115 serves as electrical signal communication means between the sliding cover 11 and the phone body 12 and serves as trigger. It is well understood by those skilled in the art that the first signal contact 115 may be replaced by a flexible terminal or gold finger without departing from the scope and spirit of the invention.

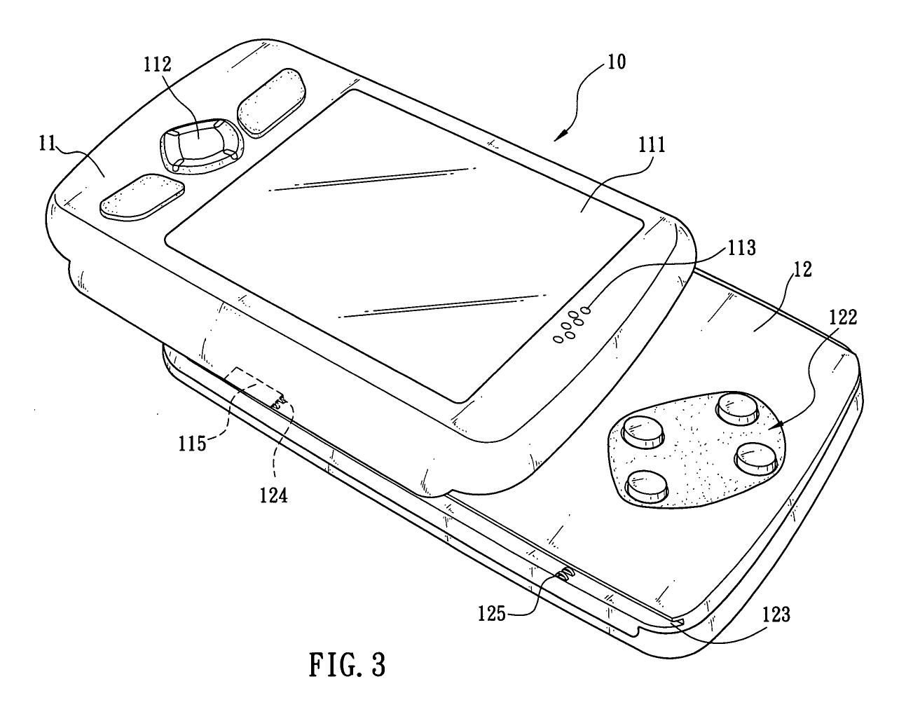

Referring to FIGS. 1, 2, and 3 components of the phone body 12 and its assembly with the back of the sliding cover 11 according to the preferred embodiment of the invention will be described in detailed below. The phone body 12 comprises a keypad 121 (see FIG. 2) and a button region 122 (see FIG. 3). The keypad 121 and the button region 122 are provided adjacent to both ends of the phone body 12. Both the keypad 121 and the button region 122 serve to communicate signals for function keys provided thereon. In the embodiment, the keypad 121 comprises a plurality of function keys for mobile phone and a microphone and the button region 122 comprises a plurality of function keys for video games. It is well understood by those skilled in the art that each of the keypad 121 and the button region 122 may comprise function keys for purposes other than mobile phone and video games (e.g., other function keys provided on the sliding cover 11) without departing from the scope and spirit of the invention.

Moreover, two lengthwise grooves 123 are provided on both sides of the phone body 12. The grooves 123 are adapted to matingly engage with the troughs 114 such that the former may slide thereover and vice versa. An inner surface of either groove 123 faces the first signal contact 115. Also, a second signal contact 124 (see FIGS. 1 and 2) and a third signal contact 125 (see FIGS. 1 and 3) are provided on the inner surface of one of the grooves 123. The second signal contact 124 is located adjacent to the keypad 121 and the third signal contact 125 is located adjacent to the button region 122. Both the second signal contact 124 and the third signal contact 125 serve as electrical signal communication means between the first signal contact 115 of the sliding cover 11 and the phone body 12 and serve as trigger. It is well understood by those skilled in the art that each of the second signal contact 124 and the third signal contact 125 may be replaced by a flexible terminal or gold finger without departing from the scope and spirit of the invention.

Referring to FIG. 1 again, it is clear that by configuring components as above the smartphone 10 may operate as a typical PDA when the phone body 12 is fully covered by the sliding cover 11. Referring to FIG. 2 again, alternatively the sliding cover 11 moves to the other end of the phone body 12 by sliding the troughs 114 over the grooves 123 to expose the keypad 121 (i.e., function keys for mobile phone) of the phone body 12. At this position, the smartphone 10 may operate as a typical mobile phone and the first signal contacts 115 electrically contact the third signal contacts 125. Referring to FIG. 3 again, still alternatively the sliding cover 11 moves to one end of the phone body 12 by oppositely sliding the troughs 114 over the grooves 123 to expose the button region 122 (i.e., function keys for video games) of the phone body 12. At this position, the smartphone 10 may operate as a typical video game machine and the first signal contacts 115 electrically contact the second signal contacts 124.

While the invention herein disclosed has been described by means of specific embodiments, numerous modifications and variations could be made thereto by those skilled in the art without departing from the scope and spirit of the invention set forth in the claims.

What is claimed is:

1. A smartphone comprising:
a sliding cover including a screen provided on its top surface, a direction button provided on its top surface, two troughs provided at both sides of its bottom surface, and a first signal contact provided under one of the troughs; and
a phone body including a keypad provided adjacent to one end of its top surface, a button region provided adjacent to the other end of its top surface, two lengthwise grooves provided on its both sides, the grooves being adapted to matingly engage with the troughs such that both the grooves and the troughs are adapted to slide relative to each other, and second and third signal contacts provided on an inner surface of either groove wherein the second signal contact is located adjacent to the keypad and the third signal contact is located adjacent to the button region.

2. The smartphone of claim 1, further comprising an intermediate first signal contact provided under one of the troughs.

3. The smartphone of claim 2, wherein the first signal contact is either a flexible terminal or a gold finger.

4. The smartphone of claim 3, wherein the keypad includes a plurality of function keys for mobile phone and a microphone.

5. The smartphone of claim 3, wherein the button region includes a plurality of function keys for video games.

6. The smartphone of claim 4, wherein the second signal contact and the third signal contact are provided on the inner surface of one of the grooves.

7. The smartphone of claim 5, wherein the second signal contact and the third signal contact are provided on the inner surface of one of the grooves.

8. The smartphone of claim 6, wherein each of the second signal contact and the third signal contact is a flexible terminal or a gold finger.

9. The smartphone of claim 7, wherein each of the second signal contact and the third signal contact is a flexible terminal or a gold finger.

10. The smartphone of claim 6, further comprising a speaker provided on the top surface of the sliding cover, and wherein the direction button is provided adjacent to one end of the screen and the speaker is provided adjacent to the other end of the screen.

11. The smartphone of claim 7, further comprising a speaker provided on the top surface of the sliding cover, and wherein the direction button is provided adjacent to one end of the screen and the speaker is provided adjacent to the other end of the screen.
